(19) United States
(12) Patent Application Publication
(10) Pub. No.: US 2006/0172184 A1
(43) Pub. Date: Aug. 3, 2006

(54) Battery storage structure for a waterproof electric instrument

(75) Inventor: Kenji Hasuda, Shinagawa-ku (JP)

Correspondence Address: DARBY & DARBY P.C., P. O. BOX 5257, NEW YORK, NY, 10150-5257, US

(73) Assignee: SMK CORPORATION, Tokyo (JP)

(21) Appl. No.: 11/270,713

(22) Filed: Nov. 8, 2005

(30) Foreign Application Priority Data
Feb. 3, 2005 (JP) 2005-027172

(51) Int. Cl. H01M 2/10; B65D 85/00

(52) U.S. Cl. 429/99; 429/100; 206/703

(57) ABSTRACT

A battery storage structure for a waterproof electric instrument comprises battery holders on whose both ends are arranged a pair of electrodes which come in contact with electrode sections of cylindrical batteries; a box-shaped case for a waterproof electric instrument which houses the battery holders; a battery loading orifice to load the cylindrical batteries from outside of the case to the battery holders; a loading orifice closing lid operable to open and close the battery loading orifice; and a water-tight seal to hermetically close the loading orifice closing lid against the battery loading orifice, wherein the loading orifice closing lid and the battery loading orifice have a screw section, both screw sections being able to screw together, and wherein the loading orifice closing lid screws into the battery loading orifice, thereby hermetically closing the battery loading orifice.

### INCORPORATION BY REFERENCE

The present application claims priority under 35 U.S.C. § 119 to Japanese Patent Application No. 2005-027172, filed on Feb. 3, 2005, in the Japanese language. The content of JP Application No. 2005-027172 is hereby incorporated by reference in its entirety.

### FIELD OF THE INVENTION

The present invention pertains to a battery storage structure, and more particularly to a waterproof battery storage structure.

### BACKGROUND OF THE INVENTION

Generally, electric instruments such as a remote control for use in a bathroom to operate a water heater, a heating apparatus and so forth which are installed inside the bathroom have a structure in which cylindrical batteries are employed as a power supply. Because of the moist, wet environment where such remote controls are used, there is a risk of electric shock and so forth. Therefore, a excellent waterproof performance is required in the battery storage section.

Battery storage structures for waterproof electric instruments are known. FIG. 5 illustrates one such prior art battery storage structure for a waterproof electric instrument which comprises a case 1 that forms an outer shell of the electric instrument; a battery holder 3 which is housed in case 1 and holds cylindrical batteries 2; a battery loading orifice 4, through which the cylindrical batteries 2 are loaded from outside of the case 1 into the battery holder 3; a loading orifice closing lid 5, to close the battery loading orifice 4; and a water-tight seal 6 to hermetically close the battery loading orifice 4 with the loading orifice closing lid 5. The loading orifice closing lid 5 closes the battery loading orifice 4, and the loading orifice closing lid 5 is fixed on the case 1 using fastening screw members 7, thereby hermetically closing the battery loading orifice 4.

The conventional technology has a structure in which a loading orifice closing lid is closed using fastening screw members and hence, the pressure given by the loading orifice closing lid onto a water-tight seal is concentrated on areas around the fastening screw members and does not act uniformly on the water-tight seal. Therefore, this arrangement is problematic in that it cannot provide for sufficient waterproof performance. Moreover, a screwdriver or a coin needs to be employed for attaching and detaching the fastening screw members, making these processes cumbersome. Furthermore, when the fastening screw members are arranged in the central section of the loading orifice closing lid, i.e., inside the water-tight material, water-tight seals such as O-rings have to be provided between the fastening screw members and the loading orifice closing lid, complicating the structure and increasing cost. Alternatively, when the fastening screw members are arranged outside the water-tight material the fastening section has to be provided in the outer circumference of the loading orifice closing lid, thereby preventing an electric instrument from being miniaturized.

What is needed in the art is a battery storage structure that provides a uniform water-tight seal that can be easily opened and closed. The present invention satisfies one or more of these and other needs.

### SUMMARY OF THE INVENTION

The present invention relates to a battery storage structure for a waterproof electric instrument. A battery storing structure embodying the present invention has excellent waterproof performances and allows batteries to be loaded and unloaded with ease.

In one aspect of the invention, the battery storage structure includes battery holders having first and second ends, each of the first and second ends have a pair of electrode terminals which come in contact with electrode sections of cylindrical batteries. The cylindrical batteries are loaded between both electrode terminals as they travel in a direction which intersects a line connecting the pair of electrode terminals. Further included is a box-shaped case for a waterproof electric instrument which houses said battery holders, a circular battery loading orifice through which the batteries are loaded, and a loading orifice closing lid operable to open and close the battery loading orifice. The structure creates a water-tight seal to hermetically close the loading orifice closing lid against said battery loading orifice. The loading orifice closing lid and the battery loading orifice have mating screw sections, so that the loading orifice closing lid screws into the battery loading orifice, thereby hermetically closing the battery loading orifice.

The battery holders are arranged so that one end of each of the battery holders is located beyond the circular opening of the battery loading orifice, and the other end is located within the circular opening. Thus, one end of each of the cylindrical batteries loaded into said battery holders resides under an area of the case around the battery loading orifice.

In accordance with additional aspects of the invention a plurality of battery holders can be provided in an arrangement in which they are shifted with each other in the longitudinal direction. One end of some of the cylindrical batteries loaded into the battery holders resides under an area of the case on one side of the battery loading orifice, while one end of the other of the cylindrical batteries loaded into the battery holders resides under an area of the case on the other side of the battery loading orifice.

The loading orifice closing lid can also include a handle for rotation which is integrally provided on its surface.

These and further objectives, features and advantages of the present invention will become more apparent from the following description when taken in connection with the accompanying drawings which show, for purposes of illustration only, several embodiments in accordance with the present invention.

### BRIEF DESCRIPTION OF THE FIGURES

FIG. 1 is a perspective view which illustrates an electric instrument having the battery storage structure in accordance with an embodiment of the present invention;

FIG. 2 is a cross sectional view along lines 2-2 of FIG. 1;

FIG. 3 is a top view of FIG. 1 with a portion of the case removed;

FIG. 4a is a perspective top view which illustrates a loading orifice closing lid in accordance with an aspect of the present invention;

FIG. 4b is a perspective bottom view of the loading orifice closing lid of FIG. 4a;

FIG. 5a is a top view of a conventional battery storage structure; and

FIG. 5b is a cross sectional view of the battery storage structure of FIG. 5a.

### DESCRIPTION OF THE ILLUSTRATED EMBODIMENTS

The following detailed description illustrates the invention by way of example and not by way of limitation. This description clearly enables one skilled in the art to make and use the invention, and describes several embodiments, adaptations, variations, alternatives and uses of the invention. It should be understood that any feature described in one embodiment can be equally applied to any other embodiment without departing from the spirit of the present invention. The same reference numbers given in multiple figures indicates identical items.

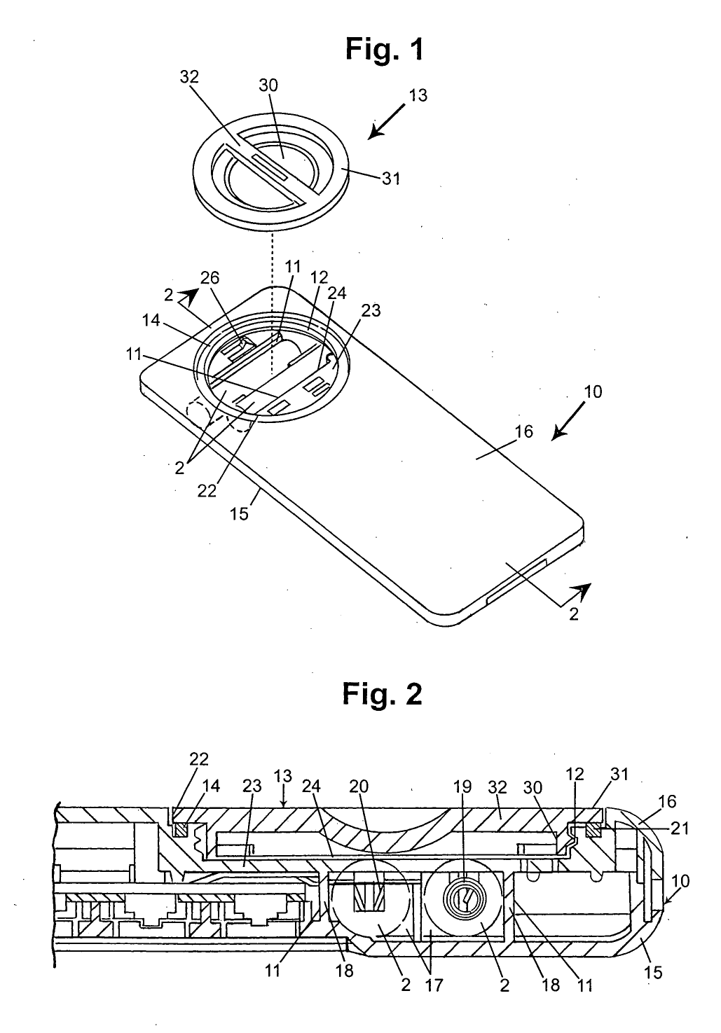

FIG. 1 illustrates a remote control for use in a bathroom. The remote control includes a waterproof electric instrument having a battery storage structure embodying an aspect of the present invention. The remote control comprises an electronics board in a box-shaped waterproof case 10 and is designed to function using two cylindrical batteries 2 as a power supply (e.g., AA or AAA batteries).

Referring to FIG. 2, the structure of the section of the remote control which stores the cylindrical batteries 2 comprises battery holders 11 which hold the cylindrical batteries 2. Box-shaped case 10 encases a waterproof electric instrument and houses battery holders 11 therein. A circular battery loading orifice 12 is formed on the case 10 and aligned against the positions of the battery holders 11. A loading orifice closing lid 13 is operable to open and close battery loading orifice 12. The loading orifice closing lid 13 can be opened to load and unload cylindrical batteries 2 through the battery loading orifice 12.

A ring-shaped, water-tight seal 14, which is made of an elastic material such as rubber, is disposed between the loading orifice closing lid 13 and the battery loading orifice 12 so as to hermetically close the loading orifice closing lid 13 against the battery loading orifice 12.

The case 10 for a waterproof electric instrument is formed with a front case 15 and a back case 16 which have a shape of front and back portions, respectively, into which a thin rectangular box made of a synthetic resin material split. The battery holders 11 are integrally formed inside the lower end section of the front case 15 and the battery loading orifice 12 is formed through a section of the back case 16 facing the battery holders 11.

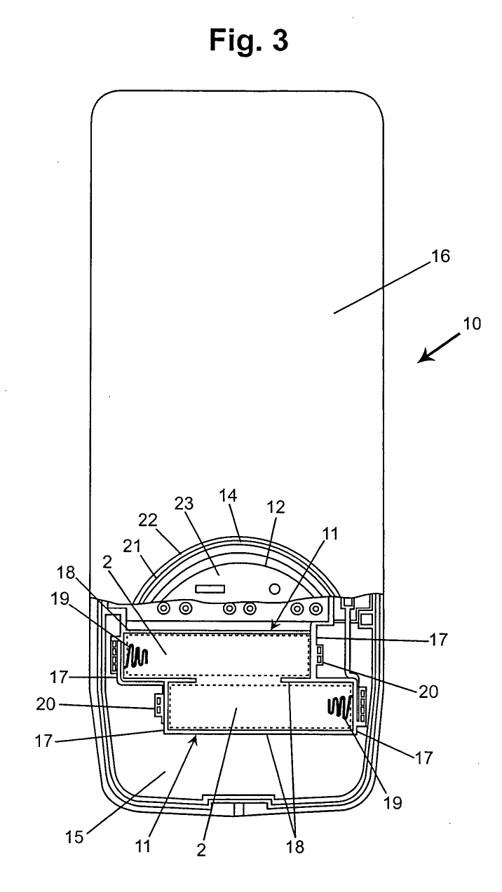

Referring to FIG. 3, the battery holders 11 comprise end panels 17, which rise on, and integrally with, an inner surface of the front case 15 and side panels 18, which are arranged on the side sections of the end panels 17. The inner side surface of the front case 15 serves as a bottom panel of the battery holders 11. The battery holders 11 are configured in a box shape whose battery loading orifice 12 side is open. The battery holders 11 are integrally formed such that they are shifted with respect to each other in the longitudinal direction.

The sides of the end panels 17 that are facing one another support electrode terminals 19 and 20, respectively, which are in contact with the electrodes of cylindrical batteries 2.

The cylindrical batteries 2 are loaded between both electrode terminals 19 and 20 from the sides of battery holders 11 which are open, in other words, they are loaded as they travel in a direction which intersects a line connecting both electrode terminals (which is the direction of a diameter of the cylindrical batteries that is perpendicular to the bottom panel when the batteries are loaded between both electrode terminals).

Electrode terminals 19 are made of coil springs (preferably, a conical spiral shape), which elastically come in contact with one electrode of the batteries 2. The electrode terminals 19 provide a bias pressure on the loaded cylindrical batteries 2 toward the other electrode terminal 20. The cylindrical batteries 2 are loaded in the battery holders 11 by pressing one of the electrodes (e.g., the anode) onto the electrode terminal 19 and rotating the batteries 2 with the electrode section as a center. Then, the other electrode (e.g., the cathode) is brought into contact with the electrode terminal 20.

In accordance with an alternative arrangement, the battery loading orifice 12 is formed in a circular shape through a back surface panel of the back case 16 and a female screw section is formed on an inner periphery thereof.

The diameter of the battery loading orifice 12 is smaller than the length of the cylindrical batteries 2, and the size of the battery loading orifice 12 is large enough to allow the cylindrical batteries 2 to be loaded into battery holders 11 in the case 10. When observed from the side of the battery loading orifice 12, the battery holders 11 are arranged so that one end of the battery holders is covered with an area of the case 10 around the battery loading orifice 12, and an end section of the cylindrical batteries 2 resides under the area of the case 10 around the battery loading orifice 12 when they are loaded in the battery holders 11.

The battery loading orifice 12 is arranged so that the ends of the battery holders 11 are located outside of the circular periphery of the orifice, i.e., under the area of the case 10 around the battery loading orifice 12. The ends with the electrode terminals 20 are located inside the circular periphery, i.e., in positions which are exposed through the battery loading orifice 12. The electrode terminals 19 are made of coil springs. The anode ends of the cylindrical batteries 2 are inserted into the case 10 such as to bring them to elastically contact the electrode terminals 19. While the batteries 2 press against the electrode terminals 19, the batteries rotate around the anodes as centers, thereby being loaded into the battery holders 11.

The battery holder arrangement discussed above allows the cylindrical batteries 2 to be loaded into the battery holders 11 in an efficient manner even when the diameter of the battery loading orifice 12 is smaller than the length of the cylindrical batteries 2. A smaller diameter of the battery loading orifice 12 enables a waterproof electric instrument to be miniaturized.

In the periphery of the battery loading orifice 12, a seal groove is formed, within which the water-tight seal 14 engages. In the outer circumference of the groove 21, a concave section 22 is formed, into which a part of the loading orifice closing lid 13 engages.

Further, a cover 23 with a circular panel shape is bonded on an inside opening section of the battery loading orifice 12, and the cylindrical batteries 2 are loaded into the battery holders 11 through insertion holes 24 which are formed through the cover 23.

The insertion holes 24 are formed in an arrangement in which they are shifted with respect to each other in the longitudinal direction in accordance with the arrangement of the battery holders 11.

An elastic latch piece 26, which latches together with a latch projection 25 (formed on the back surface of the loading orifice closing lid 13) is integrally formed on the surface of the cover 23.

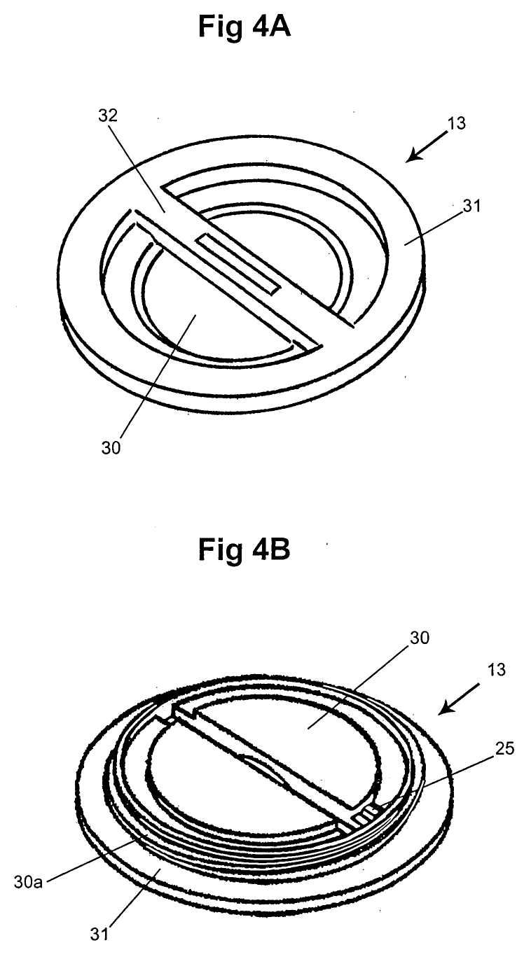

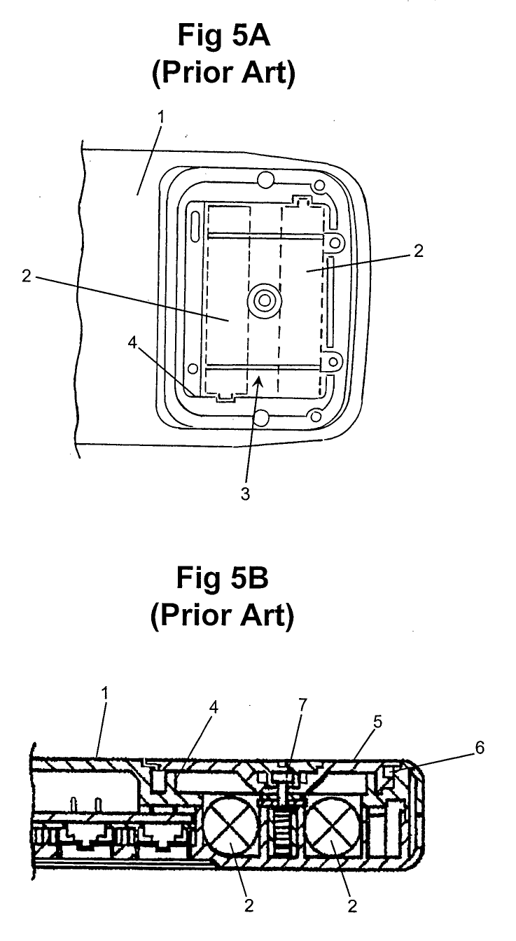

As shown in FIG. 4, the battery loading orifice closing lid 13 integrally comprises a lid main body 30 in a shape of a cylinder with a bottom and an open end; a flange 31 which extends outward from the periphery of the opening of the lid main body 30; and a handle for rotation 32 which is protuberant on the surface of the bottom panel of the lid main body 31.

The loading orifice closing lid 13 comprises a male screw section 30a on the outer circumference of the lid main body 30. The male screw section 30a engages with a female screw section on the inner periphery of the battery loading orifice 12, so as to screw the loading orifice closing lid 13 into the battery loading orifice 12, thereby closing the battery loading orifice 12. At the same time, the flange 31 engages in the concave section 22 while uniformly compressing the water-tight seal 14, and thus the battery loading orifice 12 is hermetically closed.

As the loading orifice closing lid 13 screws into the battery loading orifice 12 the back surface of the bottom panel of the lid main body 30 engages with the elastic latch piece 26 which is formed on the surface of the cover 23, so as to prevent the loading orifice closing lid 13 from rotating further. Rotating the loading orifice closing lid 13 in the opposite direction will remove the loading orifice closing lid 13 from the battery loading orifice 12.

As described above the water-tight seal 14 engages into the groove formed in the periphery of the battery loading orifice 12. In accordance with alternative arrangements, the water-tight seal 14 may be provided between the inner circumference surface of the battery loading orifice and the outer circumference surface of the loading orifice closing lid, or may be held on the loading orifice closing lid.

Moreover, the embodiment described above employs a coil spring for one or both electrode terminals. It will suffice, however, that the electrode terminal elastically comes in contact with one end of a battery such as by employing a leaf spring. Moreover, a structure may be employed in which both electrode terminals elastically come in contact with respective electrode sections of a battery.

In the embodiment described above, a remote control for use in a bathroom was cited as an example of a waterproof electric instrument in which the present invention can be utilized. One of ordinary skill in the art will realize that the present invention can be utilized in other applications such as television sets, mobile communication devices such as a cellular phone and cameras, lighting equipment such as flashlights, and any other electric instruments which employ cylindrical batteries as a power supply.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed. Substitutions of elements from one embodiment to another are also fully intended and contemplated. The invention is defined solely with regard to the claims appended hereto, and equivalents of the recitations therein.

We claim:

1. A battery storage structure for a waterproof electric instrument comprising:
battery holders having first and second ends, each of the first and second ends having a pair of electrode terminals configured to contact electrode sections of cylindrical batteries;
a case of an electronic instrument which houses said battery holders;
a circular battery loading orifice operable to load said cylindrical batteries from outside of said case into said battery holders;
a loading orifice closing lid operable to open and close said battery loading orifice; and
a water-tight seal to hermetically close said loading orifice closing lid against said battery loading orifice;
wherein said loading orifice closing lid and said battery loading orifice have mating screw sections, and wherein said loading orifice closing lid screws into said battery loading orifice, thereby hermetically closing said battery loading orifice.

2. The battery storage structure according to claim 1, wherein the battery holders are arranged so that one end of each of the battery holders is located beyond the circular opening of the battery loading orifice, and the other end is located within the circular opening, and wherein one end of each of the cylindrical batteries which are loaded in said battery holders resides under an area of the case around the battery loading orifice.

3. The battery storage structure according to claim 2, further comprising:
a plurality of battery holders provided in an arrangement in which they are shifted with respect to each other in a longitudinal direction; and
one end of a portion of the cylindrical batteries loaded in a first portion of the plurality of battery holders reside under an area of the case on one side of the battery loading orifice, while one end of a second portion of the cylindrical batteries loaded into a second portion of the plurality of battery holders reside under an area of the case on the other side of the battery loading orifice.

4. The battery storage structure according to claim 1, wherein the loading orifice closing lid comprises a handle for rotation which is integrally provided on its surface.
